(19) United States
(12) Patent Application Publication
(10) Pub. No.: US 2019/0375087 A1
(43) Pub. Date: Dec. 12, 2019

(54) SYSTEMS AND METHODS FOR A MULTI-TOOL MONEY CLIP

(71) Applicant: NITE IZE, INC., Boulder, CO (US)

(72) Inventors: Robin Liang, Guandong (CN); Andrew Valentine, Wheat Ridge, CO (US); Bowden Ormsbee, Longmont, CO (US); Rex Stevens, Longmont, CO (US)

(21) Appl. No.: 16/003,851

(22) Filed: Jun. 8, 2018

(51) Int. Cl. B25F 1/04; B25B 15/00; B26B 11/00; A45C 1/06; A45C 15/00; B67B 7/16; B67B 7/44; B67B 7/46

(52) U.S. Cl. CPC B25F 1/04; B25B 15/005; B25B 15/007; B26B 11/001; A45C 1/06; B67B 2007/303; B67B 7/16; B67B 7/44; B67B 7/30; A45C 2001/062; A45C 15/00

(57) ABSTRACT

A multifunction money clip includes a first plate and a second plate connected to the first plate via a plurality of connectors at the corners of the first and second plate, the first and second plate forming an internal area. The multifunction money clip further includes a plurality of tools each rotationally connected to the first and second plate via one of the plurality of connectors, the plurality of tools located in the internal area when retracted. The multifunction money clip further includes a double clip located on the first plate, a first portion of the double clip opening in a first direction and configured to trap items between the first plate and the clip and a second portion of the double clip opening in a second direction, opposite the first direction, and configured to trap items between the second clip portion and the first clip portion. A small clip is included opposite the double clip to attach to a pocket.

### BACKGROUND

In numerous scenarios it is desirable to have various tools for a user, without having to account for and carry such tools. Numerous small tools exist for consumers including Swiss army knives and multi-tools. One disadvantage of such devices is that the user must carry the device in addition to a wallet, smart phone, keys, or other items commonly held in one's pockets. Additionally, a consumer may forget to put such a device in their pocket and therefore be deprived of the device when in need.

### BRIEF SUMMARY

In one embodiment, a multifunction money clip includes a thin plate body portion having an internal area. The multifunction money clip further includes a plurality of rotationally extendable tools, located in the internal area. The multifunction money clip further includes a clip attached to the thin plate body portion, the clip located such that the clip is configured to trap items between the thin plate body portion and the clip. In one alternative, the clip includes a double clip, a first portion of the double clip opening in a first direction and a second portion of the double clip opening in a second direction, opposite the first direction, and configured to trap items between the second clip portion and the first clip portion. In another alternative, the first portion of the double clip is located nearer to the thin plate body portion than the second portion of the double clip. Alternatively, the first portion of the double clip has upturned ends forming an incline for the insertion items. Optionally, the multifunction money clip further includes a small clip, the small clip located on a first side of the thin plate body portion and the clip is located on a second side of the thin plate body. Alternatively, the plurality of rotationally extendable tools includes a box opener tool, a can opener tool, and a bottle opener tool. In another alternative, the can opener tool includes a narrowed Philips head screw driver at an end. Alternatively, the bottle opener tool includes a narrowed flat head screw driver at an end. Optionally, comprising an internal frame located in the internal area. In another alternative, the internal frame includes a stop for preventing the over-rotation of at least one of the plurality of rotationally extendable tools. In another alternative, the multifunction money clip further includes a double spring, the double spring oriented in the internal area such that the double spring interacts with at least two of the plurality of rotationally extendable tools, preventing the at least two of the plurality of rotationally extendable tools from extending. In another alternative, the multifunction money clip further includes a small clip spacer, the small clip spacer oriented in an aperture in the internal frame, the small clip spacer positioned to assist the small clip to extend from the thin plate body portion and hold the small clip to the thin plate body portion. Optionally, the box opener includes a hooked end and a notch positioned and configured to rest against the stop when the box opener is extended. Alternatively, the can opener and the bottle opener are on a first widthwise side of the thin plate body portion and the box opener is on a second widthwise side of the thin plate body portion. In another alternative, the thin plate body portion is between 2 and 5 millimeters thick. Optionally, the plurality of rotationally-extendable tools are each connected to the thin plate body portion via one of a plurality of pivot points. Alternatively, the plurality of pivot points hold a first plate side and a second plate side of the thin plate body portion together and the plurality of pivot points are located proximate to the corners of the thin plate body portion.

In one embodiment, a multifunction money clip includes a first plate and a second plate connected to the first plate via a plurality of connectors at the corners of the first and second plate, the first and second plate forming an internal area. The multifunction money clip further includes a plurality of tools each rotationally connected to the first and second plate via one of the plurality of connectors, the plurality of tools located in the internal area when retracted. The multifunction money clip further includes a double clip located on the first plate, a first portion of the double clip opening in a first direction and configured to trap items between the first plate and the clip and a second portion of the double clip opening in a second direction, opposite the first direction, and configured to trap items between the second clip portion and the first clip portion. Alternatively, the plurality of tools includes a box opener tool, a can opener tool, and a bottle opener tool.

In one embodiment, method of using a multifunction money clip includes providing a multifunction money clip including a first plate and a second plate connected to the first plate via a plurality of connectors at the corners of the first and second plate, the first and second plate forming an internal area. The multifunction money clip further includes a plurality of tools each rotationally connected to the first and second plate via one of the plurality of connectors, the plurality of tools located in the internal area when retracted. The multifunction money clip further includes a double clip located on the first plate, a first portion of the double clip opening in a first direction and configured to trap items between the first plate and the clip and a second portion of the double clip opening in a second direction, opposite the first direction, and configured to trap items between the second clip portion and the first clip portion. The method further includes placing at least one item selected from a card and money in the first portion of the double clip. The method further includes attaching the multifunction money clip to an article of clothing using a small clip attached to the second plate. The method further includes detaching the multifunction money clip from the article of clothing. The method further includes extending at least one of the plurality of tools from the multifunction money clip.

### BRIEF DESCRIPTION OF THE DRAWINGS

FIG. 1 shows one embodiment a perspective top view of a multi-tool money clip;

FIG. 2 shows a perspective bottom view of the multi-tool money clip of FIG. 1;

FIG. 3 shows a perspective top view of the multi-tool money clip of FIG. 1 with the tools extended;

FIG. 4 shows a perspective bottom view of the multi-tool money clip of FIG. 1 with the tools extended;

FIG. 5 shows a top view of the multi-tool money clip of FIG. 1;

FIG. 6 shows a top view of the multi-tool money clip of FIG. 1 with the tools extended;

FIG. 7 shows a bottom view of the multi-tool money clip of FIG. 1;

FIG. 8 shows a bottom view of the multi-tool money clip of FIG. 1 with the tools fully extended;

FIG. 9 shows a first end view of the multi-tool money clip of FIG. 1;

FIG. 10 shows a first end view of the multi-tool money clip of FIG. 1 with the tools partially extended;

FIG. 11 shows a second end view of the multi-tool money clip of FIG. 1;

FIG. 12 shows a second end view of the multi-tool money clip of FIG. 1 with the tools extended;

FIG. 13 shows a right side view of the multi-tool money clip of FIG. 1;

FIG. 14 shows a right side view of the multi-tool money clip of FIG. 1;

FIG. 15 shows a left side view of the multi-tool money clip of FIG. 1;

FIG. 16 shows a left side view of the multi-tool money clip of FIG. 1;

FIG. 17 shows an exploded view of the multi-tool money clip of FIG. 1.

### DETAILED DESCRIPTION

Certain terminology is used herein for convenience only and is not to be taken as a limitation on the embodiments of the systems and methods for multi-tool money clip. Various embodiments of a multi-tool money clip include a body portion housing various retractable tools and a money clip on a flat face of the body portion. In many embodiments, the retractable tools include a can opener, a bottle opener, and a box opener. In many embodiments, the device includes a pocket clip.

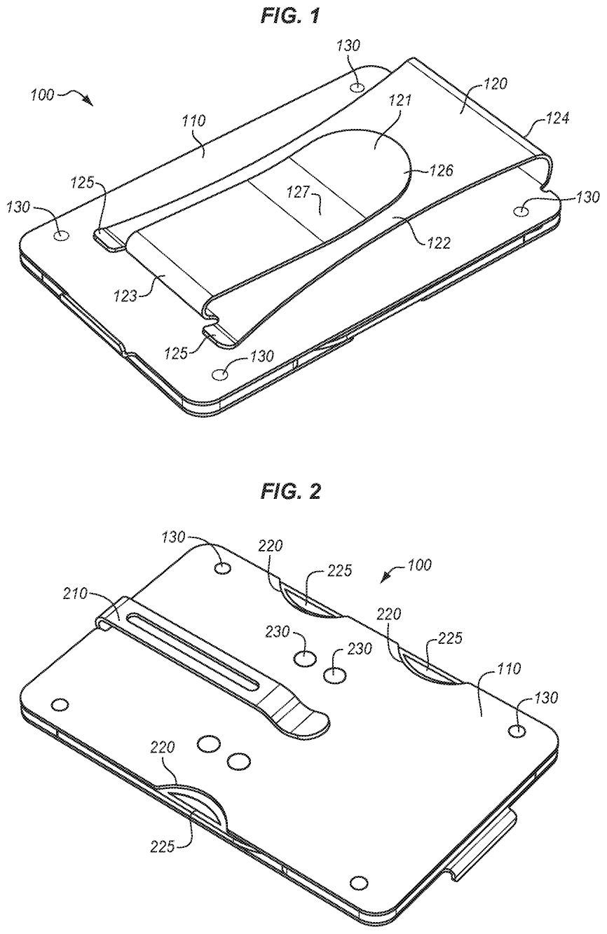

FIG. 1 shows one embodiment a perspective top view of a multi-tool money clip 100. Multi-tool money clip 100 includes a rectangular body 110. On the face of body 110 a clip 120 is mounted. Clip 120 has two clip portions 121, 122 that may use spring tension to trap clothing, cash, or credit cards. Clip portion 121 is defined by bend 123. In many embodiments, clip portion 121 is designed to hold cash. In some embodiments, clip portion 121 is generally designed and configured to be placed on a pocket of the pants of a user and has sufficient spring tension for such a purpose. Clip portion 121 is designed to hold money. Alternatively, clip portion 121 traps the fabric of a pocket between clip portion 121 and the face of clip portion 122. Clip portion 121 may be omitted in some alternatives. Clip portion 122 is defined by bend 124 and is generally designed and configured to hold credit cards, money, or other card shaped items. Generally clip portion 122 has sufficient spring tension for this purpose. Clip portion 122 traps the money and credit cards between it and the face of rectangular body 110. Rectangular body 110 generally has the shape of a credit card or similar thereto, although in alternatives, other shapes may be utilized. Clip portion 122 includes incline bends 125, which provide for an advantageous incline for the insertion of cards under clip 122. Similarly, the end 126 of clip portion 121 may bend slightly upwards to aid in the insertion of clothing between clip portion 121 and clip portion 122. Rivets 130 are also visible in this view and are used to hold the device together and provide for the extension of various tools in a rotational fashion. In many embodiments, the multi-tool money clip 100 in made of metal, such as steel or aluminum. The particular configurations shown may have very narrow depths, the depth being between 1-5 mm and in many configurations approximately 3 mm.

FIG. 2 shows a perspective bottom view of multi-tool money clip 100. The underside of body 110 is visible. Additionally, rivets 130 are shown in an underside view. A pocket clip 210 is visible in this view. Pocket clip 210 is extendable from the body 110 as will later be explained. Pocket clip 210 provides for an alternative clipping arrangement, as may be utilized in pocket. The clip extends away from the device such that the multi-tool money clip 100 may sit low in the pocket. The extension device for this is described below. Cutaways 220 reveal nail pulls 225 in each of the tools of the device. In this fashion the user may find a pull point for the extension of the tools of the device. Also shown are rivets 230, which provide for the holding of the spring arms that hold the tools of the device in a retracted or extended position.

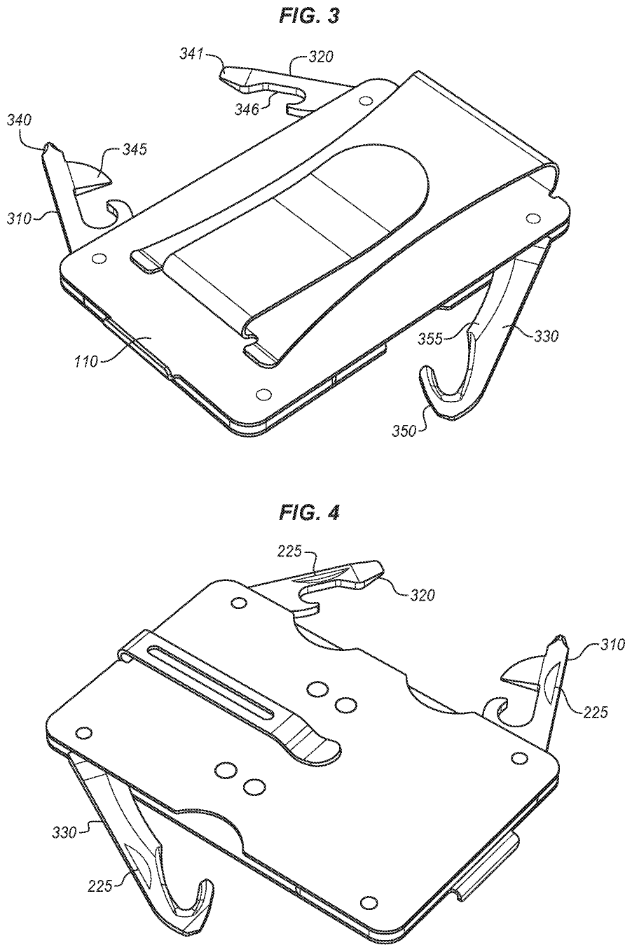

FIG. 3 shows perspective top view of a multi-tool money clip 100 with the tools partially extended. Can opener 310 includes a opener section 345 and a Philips head screw driver section 340. Bottle opener 320 includes bottle opener section 346 and flathead screw driver section 341. Box opener 330 includes hook section 350, which may include a sharpened edge for cutting boxes open. In some embodiments area 355 is also sharpened or edged and may be used as a cutting device.

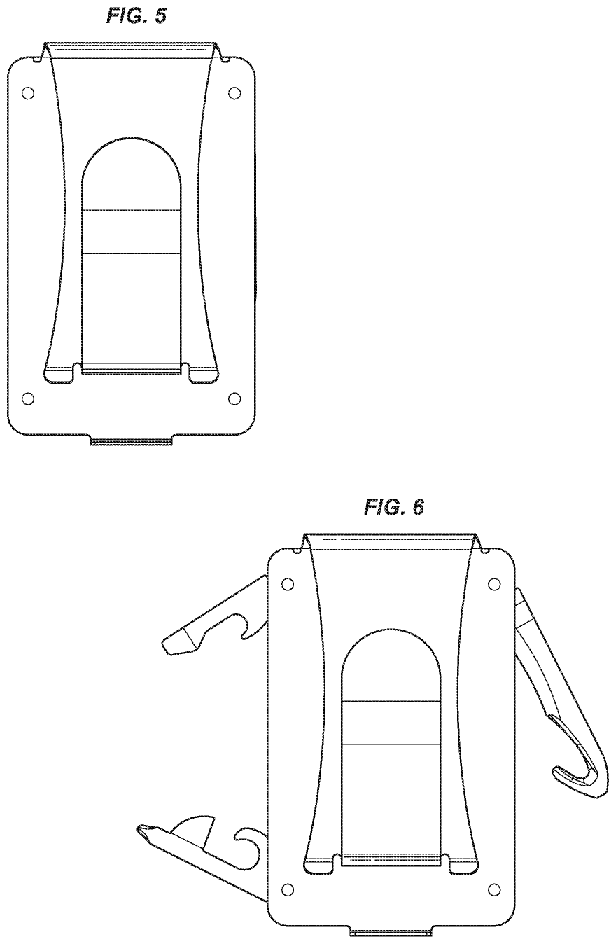

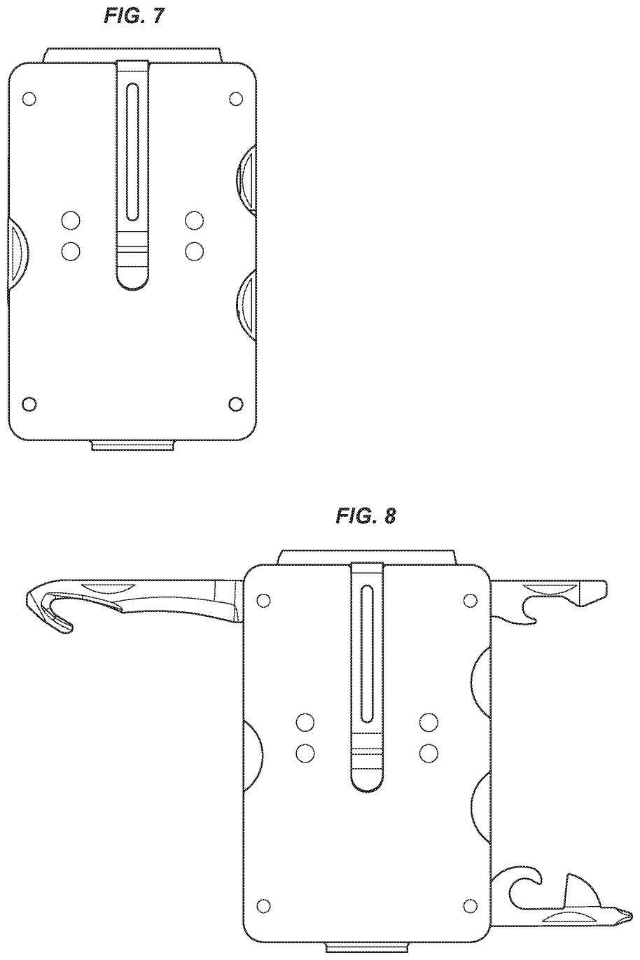

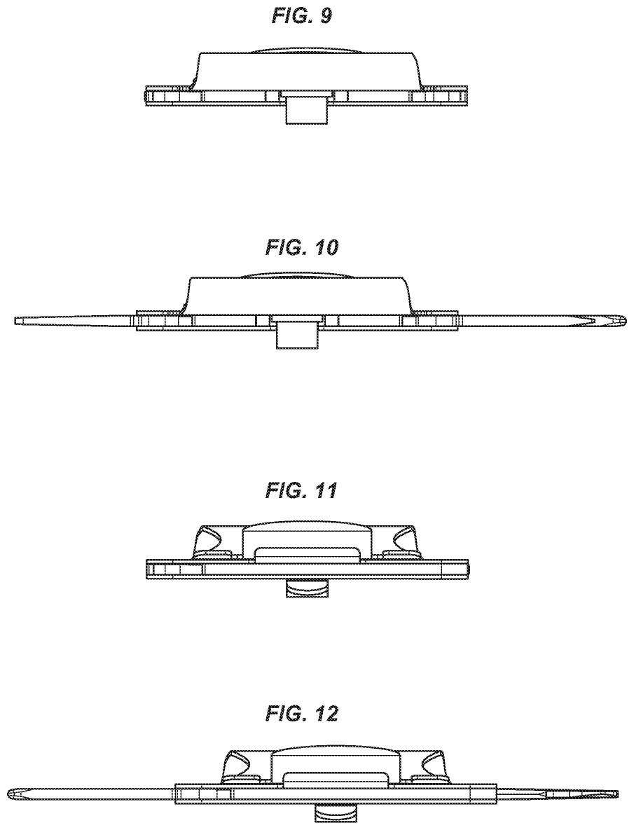

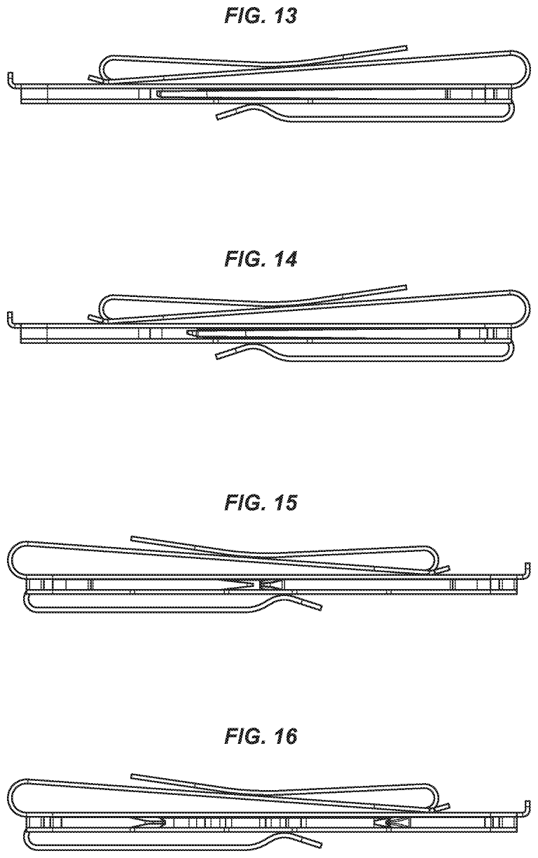

FIG. 4 shows a perspective bottom view of the multi-tool money clip of FIG. 1 with the tools partially extended. The tools extend a full 180 degrees when fully extended. FIG. 5 shows a top view of the multi-tool money clip of FIG. 1. FIG. 6 shows a top view of the multi-tool money clip of FIG. 1 with the tools extended. FIG. 7 shows a bottom view of the multi-tool money clip of FIG. 1. FIG. 8 shows a bottom view of the multi-tool money clip of FIG. 1 with the tools full extended. FIG. 9 shows a first end view of the multi-tool money clip of FIG. 1. FIG. 10 shows a first end view of the multi-tool money clip of FIG. 1 with the tools extended. FIG. 11 shows a second end view of the multi-tool money clip of FIG. 1. FIG. 12 shows a second end view of the multi-tool money clip of FIG. 1 with the tools extended. FIG. 13 shows a right side view of the multi-tool money clip of FIG. 1. FIG. 14 shows a right side view of the multi-tool money clip of FIG. 1. FIG. 15 shows a left side view of the multi-tool money clip of FIG. 1. FIG. 16 shows a left side view of the multi-tool money clip of FIG. 1.

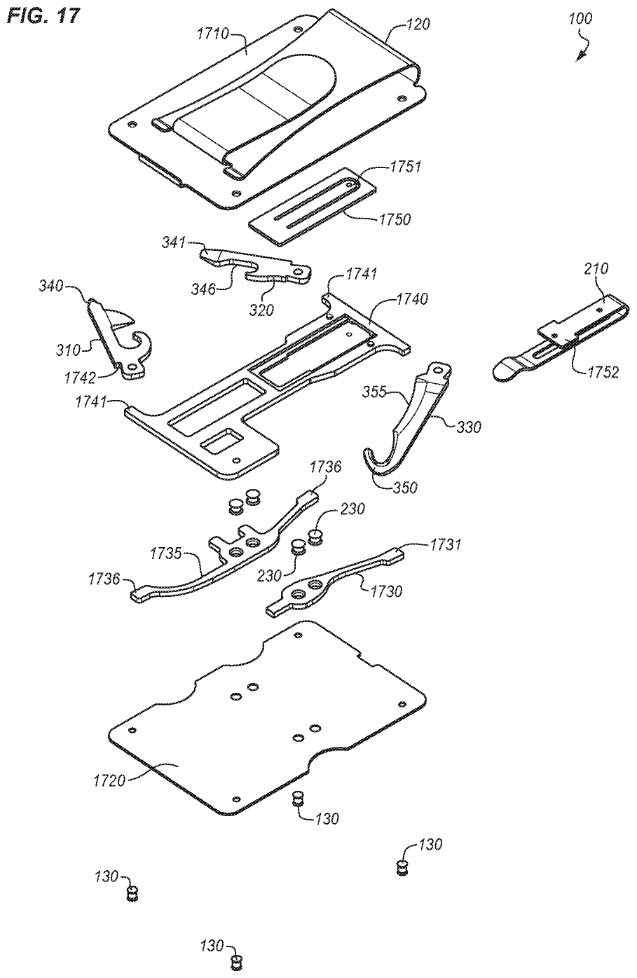

FIG. 17 shows an exploded view of the multi-tool money clip. As shown, body 110 includes face 1710 which is attached to clip 120. The device also includes face 1720. Face 1710 and face 1720 are held together via rivets 130. The faces 1710, 1720, function to sandwich the tools between them and provide for a back to the multi-tool money clip 100. As shown, single spring 1730 and double spring 1735 are held in place by rivets 230. Single spring 1730 and double spring 1735 push against the tools at spring heads 1731, 1736.

Multi-tool money clip 100 includes a spacer or internal frame 1740. Spacer 1740 includes end stops 1741 that prevent the over-rotation of the various tools. Visible here are can opener 310, bottle opener 320, and box opener 330. These tools mount on the respective rivets 130 in the corners of the device. The notch 1742 on the back side of can opener 310 (and similarly on the other tools), interact with the end stops 1741 to prevent over-rotation. Additionally, the device includes pocket clip spacer 1750. Pocket clip spacer 1750 includes a slot 1751 for pocket clip 210 to slide in and extend from, where extension 1752 slides in the slot.

Multi-tool money clip 100 differs significantly from other multi-tools, for some of the following reasons. It provides for ultra-thin construction. Multi-tool money clip 100 provides for this while still offering three extendable tools. Other tools may offer 3 extendable tools, but typically two of the tools rotate around the same vertex, increasing the thickness of the tool. Additionally, multi-tool money clip 100 provides for a dual clip money clip that has a clip opening in one direction for holding money and cards and the other for attaching to an article of clothing or other item. Multi-tool money clip 100 includes extendable pocket clip 210 on the side opposite the money clip section

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

What is claimed as new and desired to be protected by Letters Patent of the United States is:

1. A multifunction money clip, comprising:
a thin plate body portion having an internal area;
a plurality of rotationally extendable tools, located in the internal area;
a clip attached to the thin plate body portion, the clip located such that the clip is configured to trap items between the thin plate body portion and the clip.

2. The multifunction money clip of claim 1, wherein the clip includes a double clip, a first portion of the double clip opening in a first direction and a second portion of the double clip opening in a second direction, opposite the first direction, and configured to trap items between the second clip portion and the first clip portion.

3. The multifunction money clip of claim 2, wherein the first portion of the double clip is located nearer to the thin plate body portion than the second portion of the double clip.

4. The multifunction money clip of claim 3, wherein the first portion of the double clip has upturned ends forming an incline for the insertion items.

5. The multifunction money clip of claim 4, further comprising:
a small clip, the small clip located on a first side of the thin plate body portion and the clip is located on a second side of the thin plate body, the small clip extendable from out from the thin plate body.

6. The multifunction money clip of claim 5, wherein the plurality of rotationally extendable tools includes a box opener tool, a can opener tool, and a bottle opener tool.

7. The multifunction money clip 6, wherein the can opener tool includes a narrowed Philips head screw driver at an end.

8. The multifunction money clip 7, wherein the bottle opener tool includes a narrowed flat head screw driver at an end.

9. The multifunction money clip 8, further comprising an internal frame located in the internal area.

10. The multifunction money clip 9, wherein the internal frame includes a stop for preventing the over-rotation of at least one of the plurality of rotationally extendable tools.

11. The multifunction money clip 10, further comprising a double spring, the double spring oriented in the internal area such that the double spring interacts with at least two of the plurality of rotationally extendable tools, preventing the at least two of the plurality of rotationally extendable tools from extending.

12. The multifunction money clip of claim 11, further comprising a small clip spacer, the small clip spacer oriented in an aperture in the internal frame, the small clip spacer positioned to assist the small clip to extend from the thin plate body portion and hold the small clip to the thin plate body portion.

13. The multifunction money clip of claim 12, wherein the box opener includes a hooked end and a notch positioned and configured to rest against the stop when the box opener is extended.

14. The multifunction money clip of claim 13, wherein the can opener and the bottle opener are on a first widthwise side of the thin plate body portion and the box opener is on a second widthwise side of the thin plate body portion.

15. The multifunction money clip of claim 14, wherein the thin plate body portion is between 2 and 5 millimeters thick.

16. The multifunction money clip of claim 15, wherein the plurality of rotationally extendable tools are each connected to the thin plate body portion via one of a plurality of pivot points.

17. The multifunction money clip of claim 16, wherein the plurality of pivot points hold a first plate side and a second plate side of the thin plate body portion together and the plurality of pivot points are located proximate to the corners of the thin plate body portion.

18. A multifunction money clip comprising:
a first plate;
a second plate connected to the first plate via a plurality of connectors at the corners of the first and second plate, the first and second plate forming an internal area;
a plurality of tools each rotationally connected to the first and second plate via one of the plurality of connectors, the plurality of tools located in the internal area when retracted;
a double clip located on the first plate, a first portion of the double clip opening in a first direction and configured to trap items between the first plate and the clip and a second portion of the double clip opening in a second direction, opposite the first direction, and configured to trap items between the second clip portion and the first clip portion.

19. The multifunction money clip of claim 18, wherein the plurality of tools includes a box opener tool, a can opener tool, and a bottle opener tool.

20. A method of using a multifunction money clip, comprising:
providing a multifunction money clip including
a first plate;
a second plate connected to the first plate via a plurality of connectors at the corners of the first and second plate, the first and second plate forming an internal area;
a plurality of tools each rotationally connected to the first and second plate via one of the plurality of connectors, the plurality of tools located in the internal area when retracted;
a double clip located on the first plate, a first portion of the double clip opening in a first direction and configured to trap items between the first plate and the clip and a second portion of the double clip opening in a second direction, opposite the first direction, and configured to trap items between the second clip portion and the first clip portion;
placing at least one item selected from a card and money in the first portion of the double clip;
attaching the multifunction money clip to an article of clothing using a small clip attached to the second plate;
detaching the multifunction money clip from the article of clothing;
extending at least one of the plurality of tools from the multifunction money clip.
